(19) United States
(12) Patent Application Publication
(10) Pub. No.: US 2015/0354663 A1
(43) Pub. Date: Dec. 10, 2015

(54) ENGINE COVER FOR ABSORBING VIBRATION AND ASSEMBLING METHOD THEREOF

(71) Applicant: HYUNDAI MOTOR COMPANY, Seoul (KR)

(72) Inventor: Je-Yong YOON, Bucheon-si (KR)

(21) Appl. No.: 14/513,040

(22) Filed: Oct. 13, 2014

(30) Foreign Application Priority Data
Jun. 5, 2014 (KR) 10-2014-0068433

(51) Int. Cl. F16F 15/02; F02B 77/11

(52) U.S. Cl. CPC F16F 15/02; F02B 77/11

(57) ABSTRACT

An engine cover for absorbing vibration includes the engine cover enclosing an upper portion of an engine and having a lower portion provided with a plurality of cylindrical protruding parts. An upper insulator is press-fitted in a cylindrical protruding part of the engine cover to be connected to the engine cover. A vibration absorber is disposed in the cylindrical protruding part and under the upper insulator to absorb vibrations from the engine. A lower insulator is disposed in the cylindrical protruding part and under the vibration absorber and has an inner space in which a mounting bolt is press-fitted.

### CROSS-REFERENCE TO RELATED APPLICATION

This application claims the benefit of priority to Korean Patent Application No. 10-2014-0068433 filed on Jun. 5, 2014, which is incorporated herein by reference in its entirety.

### TECHNICAL FIELD

The present disclosure relates to an engine cover for absorbing vibration, and particularly, to an engine cover for absorbing vibration capable of reducing vibrations from a vehicle body by absorbing vibrations due to an abnormal frequency without mounting an additional damper.

### BACKGROUND

Conventionally, a vehicle engine is a power generator for driving a vehicle. A driving force is used as various purposes in addition to the driving of the vehicle. In particular, the vehicle is driven by a complicated electronic control, and therefore, a complicated configuration for driving the vehicle is involved. Therefore, an engine cover is mounted to simplify and improve an appearance of the complicated configuration. The engine cover, which is generally mounted to cover an upper portion of a cylinder head in the engine, reduces vibration and noise generated from the engine and prevents foreign materials such as dust from piling up.

Referring to FIGS. 1 and 2, the existing engine cover is fixedly fastened with a mounting bolt by an insulator which is a high-stiffness component. The mounting bolt is bolted to a rigid body structure such as the engine and the insulator is press-fitted (interference-fitted) in the engine cover. In a final assembling process, the assembling of the engine cover is completed by fitting the insulator, which is press-fitted (interference fit) in the engine cover, in the mounting bolt. And the engine cover is assembled in a complete fastened and fixed structure.

Referring to FIGS. 3 to 5, the existing engine inevitably generates vibrations due to a combustion pressure, which continue to the vehicle body. The vibrations from the engine may be reduced when a damper for a frequency is mounted at which the vibrations are generated. A vibration exciting force F1 is generated by the combustion pressure, and therefore, to reduce the vibration exciting force F1, the damper needs to be mounted on the engine as shown in FIG. 3. The damper has a damping structure in which rigidity K2, mass M2, and damping C2 corresponding to the vibration exciting force F1. As illustrated in FIG. 4, due to the size limitation of the engine room, the damper currently applied to the engine has a small structure. The damper is mainly to absorb the exciting frequency according to the combustion pressure. However, as illustrated in FIG. 5, vibrations due to an abnormal frequency as well as a frequency of the combustion pressure component may be excessively generated due to additional engine apparatuses, and thus, an additional damper may not be mounted due to the size limitation of the engine room.

### SUMMARY

The present disclosure is directed to a solution of a problem in that vibrations due to an abnormal frequency of an engine are from a vehicle body since an additional damper may not be mounted due to a size limitation of an engine room.

Other objects and advantages of the present disclosure can be understood by the following description, and become apparent with reference to the embodiments of the present inventive concept. Also, it is obvious to those skilled in the art to which the present disclosure pertains that the objects and advantages of the present disclosure can be realized by the means as claimed and combinations thereof.

In accordance with an embodiment of the present inventive concept, an engine cover for absorbing vibration includes the engine cover configured to enclose an upper portion of an engine and have a lower portion provided with a plurality of cylindrical protruding parts. An upper insulator is press-fitted in a cylindrical protruding part of the engine cover to be connected to the engine cover. A vibration absorber is disposed in the cylindrical protruding part and under the upper insulator to absorb vibrations from the engine. A lower insulator is disposed in the cylindrical protruding part and under the vibration absorber and have an inner space in which a mounting bolt is press-fitted.

An inside of the cylindrical protruding part may be provided with a stumbling protrusion for fixing the upper insulator.

The upper insulator may be provided with a first groove fitted in the stumbling protrusion.

The inner space of the lower insulator may be provided with a second groove in which the mounting bolt is fitted.

A lower portion of the mounting bolt may be screwed into the engine and an upper portion thereof may be connected to the lower insulator.

The upper portion of the mounting bolt may include a mounting bolt protruding part which is press-fitted in the lower insulator to be fitted in a second groove of the inner space of the lower insulator.

The lower portion of the mounting bolt may be provided with a screw fastening part which is screwed into the engine.

The engine may be provided with a fastening groove which is screwed into the screw fastening part of the mounting bolt.

In accordance with another embodiment of the present inventive concept, an assembling method of an engine cover for absorbing vibration includes a first press-fitting step of press-fitting an upper insulator in a cylindrical protruding part of the engine cover. A first vulcanized adhering step applies an adhesive to a lower portion of the upper insulator, melts a vibration absorber, and injects the melted vibration absorber into the cylindrical protruding part. A second vulcanized adhering step applies the adhesive to a lower portion of the vibration absorber, and a lower insulator is adhered to the cylindrical protruding part before the vibration absorber is solidified. A second press-fitting step press-fit a mounting bolt protruding part screwed into the engine in an inner space of the lower insulator after the vibration absorber is solidified.

In the first press-fitting step, a stumbling protrusion of the cylindrical protruding part may be fitted in the first groove of the upper insulator.

In the second press-fitting step, the mounting bolt protruding part may be fitted in a second groove of the lower insulator.

### BRIEF DESCRIPTION OF THE DRAWINGS

FIG. 1 is a perspective view of an engine cover in accordance with the related art.

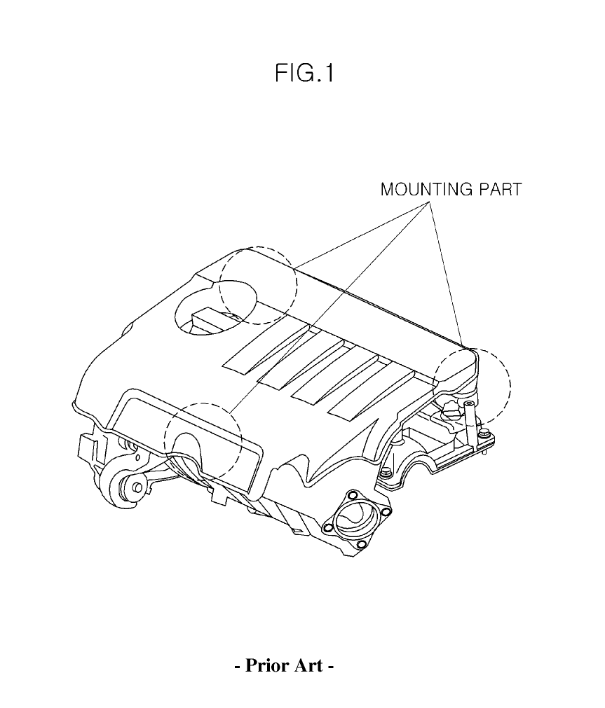

FIG. 2 is a detailed diagram of a mounting part of the engine cover in accordance with the related art.

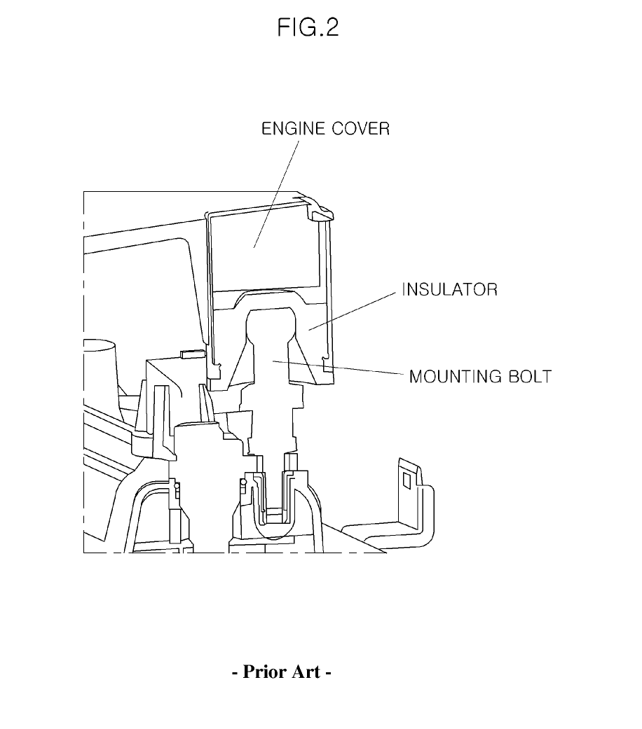

FIG. 3 is a perspective view of a damper in accordance with the related art.

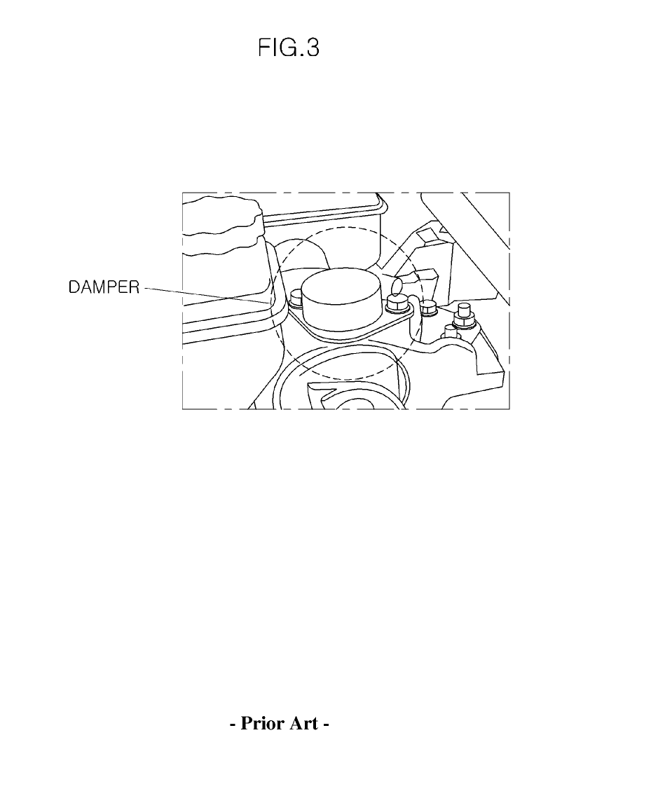

FIG. 4 is a diagram for describing a principle of the damper in accordance with the related art.

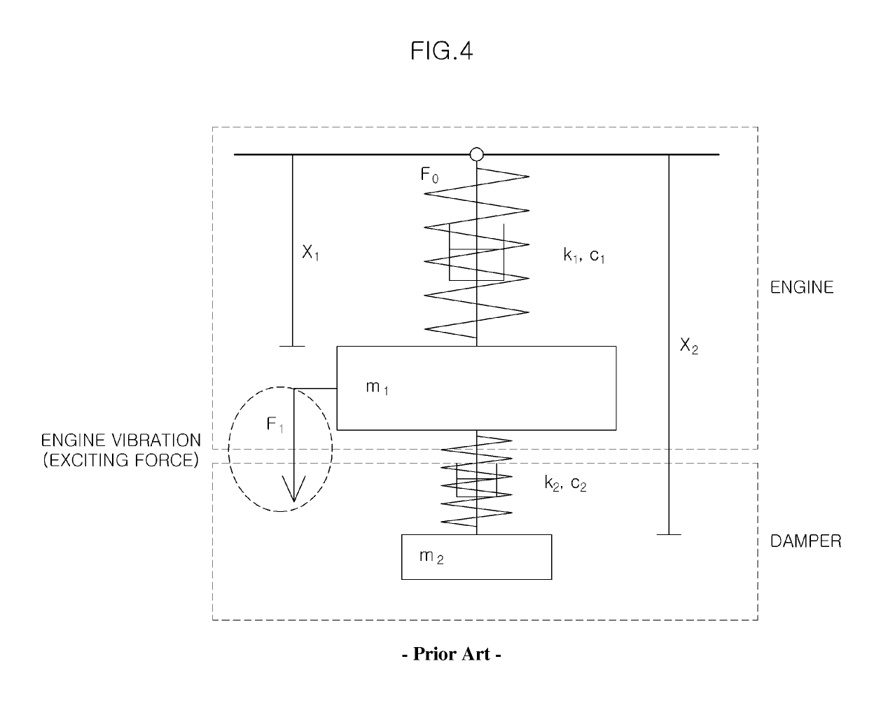

FIG. 5 is a graph illustrating a vibration measurement result of an engine in accordance with the related art.

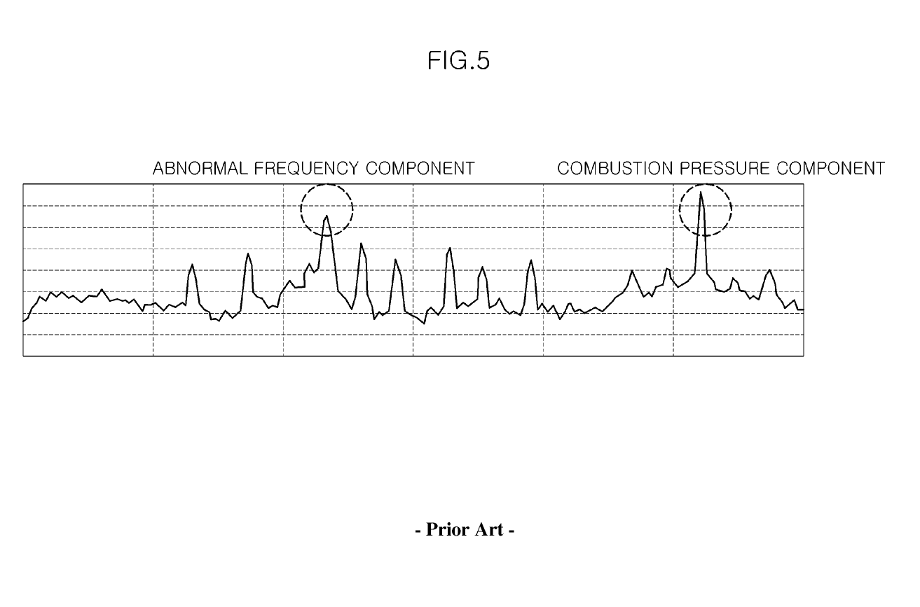

FIG. 6 is a perspective view of an engine cover for absorbing vibration in accordance with an exemplary embodiment of the present inventive concept.

FIG. 7 is a detailed diagram of the engine cover for absorbing vibration in accordance with the exemplary embodiment of the present inventive concept.

FIG. 8 is an explanation diagram of an operational principle of the engine cover for absorbing vibration in accordance with the exemplary embodiment of the present inventive concept.

FIG. 9 is a cross-sectional view illustrating a separated structure of coupled components of the engine cover for absorbing vibration in accordance with the exemplary embodiment of the present inventive concept.

FIG. 10 is a coupled cross-sectional view of FIG. 9.

FIG. 11 is a flow chart of an assembling method of an engine cover for absorbing vibration in accordance with an exemplary embodiment of the present inventive concept.

### DESCRIPTION OF SPECIFIC EMBODIMENTS

Terms and words used in the present specification and claims are not to be construed as a general or dictionary meaning but are to be construed meaning and concepts meeting the technical ideas of the present inventive concept based on a principle that the inventors can appropriately define the concepts of terms in order to describe their own inventions in best mode. Therefore, the configurations described in the exemplary embodiments and drawings of the present inventive concept are merely examples but do not represent all of the technical spirit of the present inventive concept. Thus, the present disclosure should be construed as including all the changes, equivalents, and substitutions included in the spirit and scope of the present disclosure at the time of filing this application. In the present specification, an overlapped description and a detailed description for well-known functions and configurations that may obscure the gist of the present inventive concept will be omitted. Hereinafter, exemplary embodiments of the present inventive concept will be described in detail with reference to the accompanying drawings.

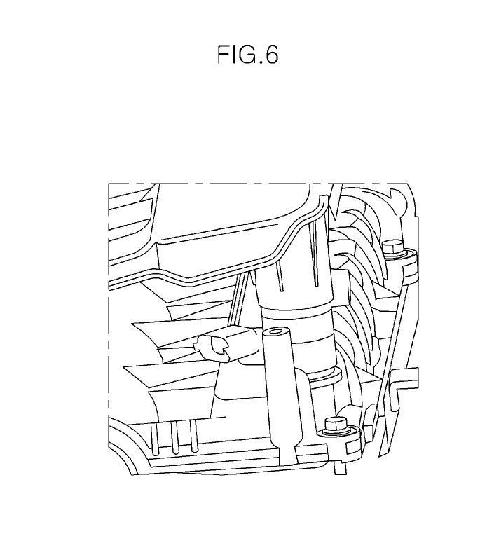

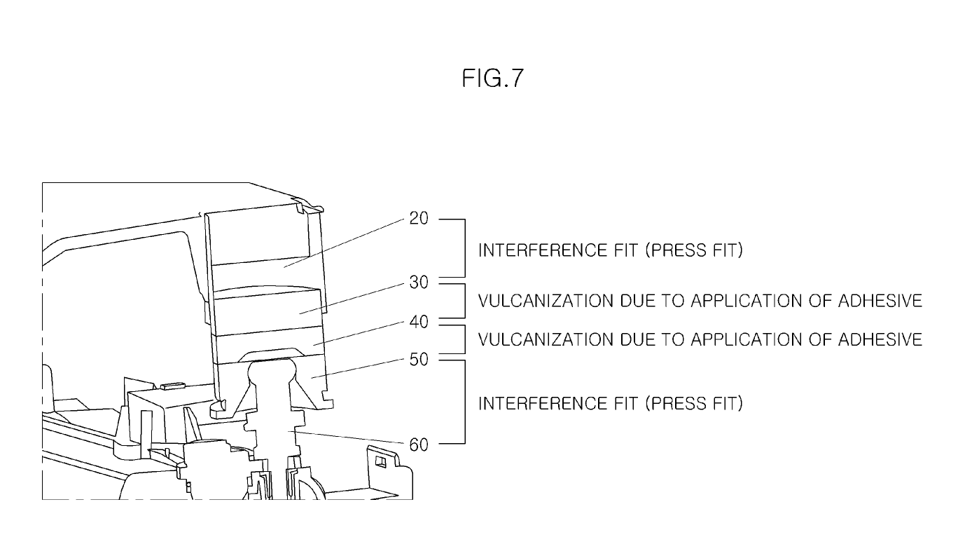

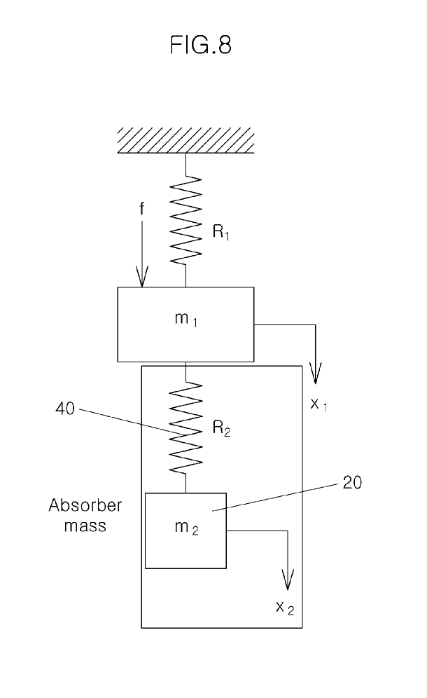

FIG. 6 is a perspective view of an engine cover for absorbing vibration in accordance with an exemplary embodiment of the present inventive concept. FIG. 7 is a detailed diagram of the engine cover for absorbing vibration in accordance with the exemplary embodiment of the present inventive concept. FIG. 8 is an explanation diagram of an operational principle of the engine cover for absorbing vibration in accordance with the exemplary embodiment of the present inventive concept. Referring to FIGS. 6 to 8, an engine cover of the exemplary embodiment of the present inventive concept is to absorb abnormal vibrations generated from an engine by a vulcanization process of a vibration absorber having lower rigidity than the existing engine cover. Compared with a mounting structure of the existing engine cover, an insulator is divided into an upper portion and a lower portion, and the vibration absorber is formed therebetween by a vulcanized adhering method. Therefore, in addition to the existing damper, the vibration absorber according to the present disclosure holds an inertial effect according to a mass of the engine cover and controls a rigidity K2 to absorb vibrations in a vibration system. The existing engine cover is used as one mass system to apply the tuned vibration absorber to an insulator mounting structure which is a support of the engine cover, thereby removing the number of abnormal vibrations of the engine vibration.

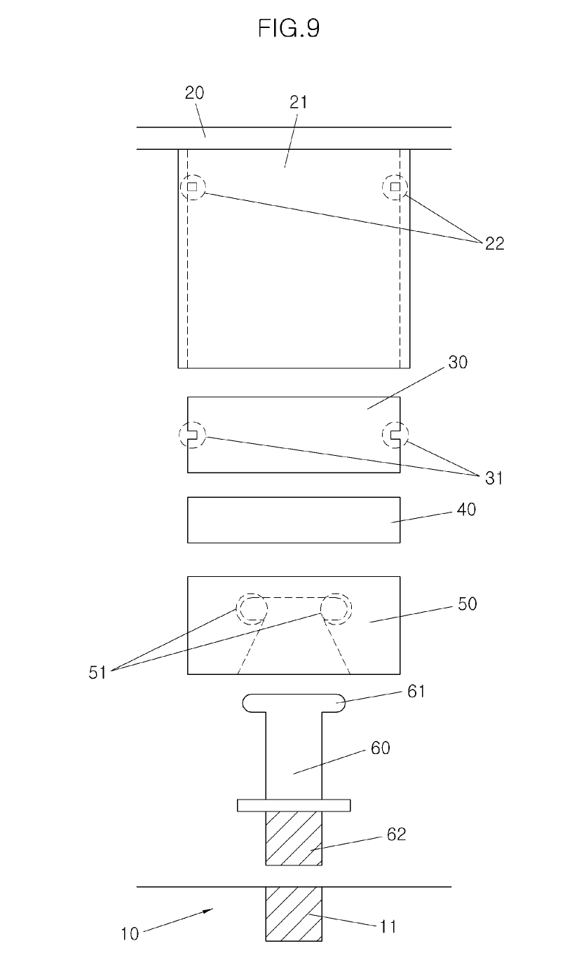

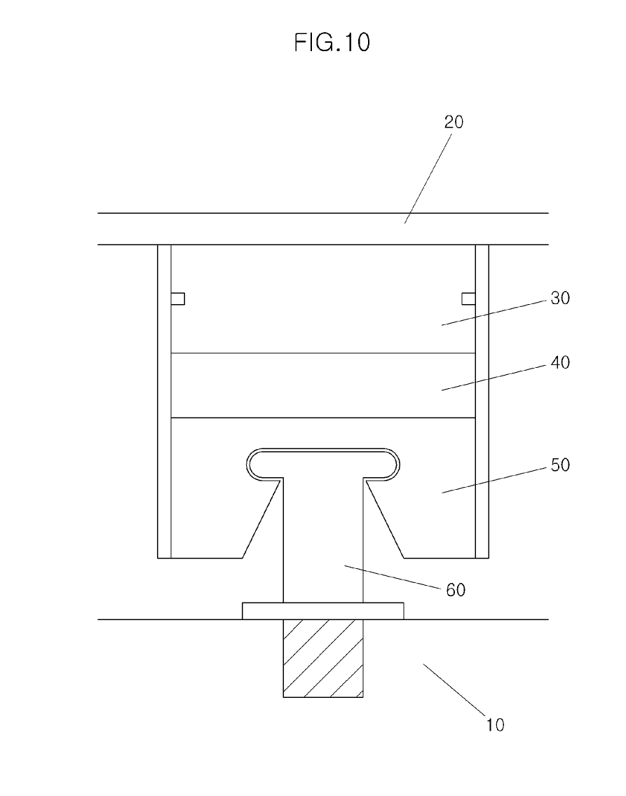

FIG. 9 is a cross-sectional view illustrating a separated structure of coupled components of the engine cover for absorbing vibration in accordance with the exemplary embodiment of the present inventive concept, and FIG. 10 is a coupled cross-sectional view of FIG. 9. Referring to FIGS. 9 and 10, the exemplary embodiment of the present inventive concept includes an engine 10, an engine cover 20, an upper insulator 30, a vibration absorber 40, a lower insulator 50, and a mounting bolt 60. The engine cover 20 encloses an upper portion of the engine 10, and a lower portion thereof is provided with a plurality of cylindrical protruding parts 21. An inside of the cylindrical protruding part 21 is provided with a stumbling protrusion 22 for fixing the upper insulator 30. The stumbling protrusion 22 has a smaller diameter than a diameter of the cylindrical protruding part 21.

The upper insulator 30 is press-fitted in the cylindrical protruding part 21 of the engine cover 20 and connected to the engine cover 20. The upper insulator 30 is provided with a first groove 31 which is fitted in the stumbling protrusion 22. A diameter of the upper insulator 30 is smaller than an inner diameter of the cylindrical protruding part 21 and is larger than the diameter of the stumbling protrusion 22. Therefore, when the upper insulator 30 is press-fitted in the cylindrical protruding part 21, the stumbling protrusion 22 is interference-fitted in the first groove 31, and thus, the upper insulator 30 is coupled with the cylindrical protruding part 20.

The vibration absorber 40 is disposed in the cylindrical protruding part 21 and under the upper insulator 30 to absorb vibrations from the engine 10. A material of the vibration absorber 40 may be elastomer such as rubber. The rigidity of the vibration absorber 40 may be tuned depending on the number of vibrations of an abnormal frequency to be absorbed. The vibration absorber 40 is connected to the upper insulator 30 by a vulcanized adhering method. The vulcanized adhering method means a method of spraying an adhesive and then melting and injecting the vibration absorber. Therefore, the vibration absorber 40 needs not be separately molded and is disposed in the cylindrical protruding part 21 and under the upper insulator 30.

The lower insulator 50 is disposed in the cylindrical protruding part 21 and under the vibration absorber 40. A lower portion of the lower insulator 50 is provided with an inner space in which the mounting bolt 60 is press-fitted. Further, the internal space of the lower insulator 50 is provided with a second groove 51 in which the mounting bolt 60 is fitted. The lower insulator 50 is connected to the vibration absorber 40 by the vulcanized adhering method. The adhesive is sprayed on the vibration absorber 40 before the vibration absorber 40 is solidified, and the lower insulator 50 adheres to the inside of the cylindrical protruding part 21.

A lower portion of the mounting bolt 60 is screwed into the engine 10, and an upper portion thereof is connected to the lower insulator 50. The lower portion of the mounting bolt 60 is provided with a screen fastening part 62 which is screwed into the engine 10, and the engine 10 is provided with a fastening groove 11 which is screwed into the screw fastening part 62 of the mounting bolt 60. Further, the upper portion of the mounting bolt 60 is provided with a mounting bolt protruding part 61 which is press-fitted in the lower insulator 50 to be fitted in the second groove 51 of the inner space of the lower insulator 50. A diameter of the inner space of the lower insulator 50 is larger than that of the mounting bolt protruding part 61, and a diameter of the second groove 51 is smaller than that of the mounting bolt protruding part 61. Therefore, when the mounting bolt 60 is press-fitted in the inner space of the lower insulator 50, the mounting bolt protruding part 61 is interference-fitted in the second groove 51 to couple the lower insulator 50 with the mounting bolt 60, and the mounting bolt 60 connects the engine 10 with the engine cover 20.

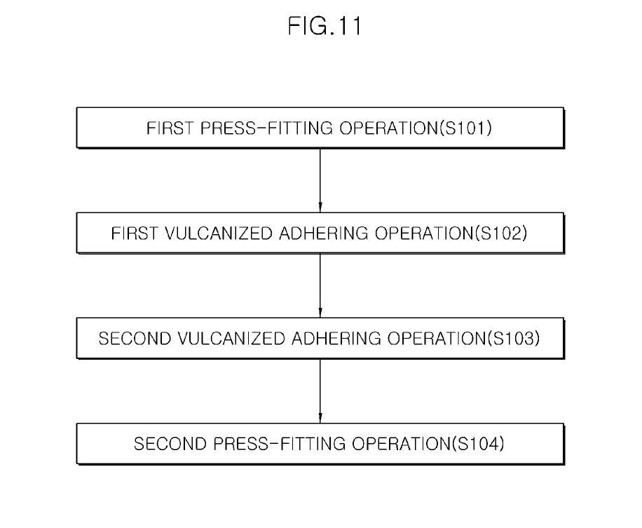

FIG. 11 is a flow chart of an assembling method of an engine cover for absorbing vibration in accordance with an exemplary embodiment of the present inventive concept. Referring to FIG. 11, the assembling method of an engine cover for absorbing vibration in accordance with an exemplary embodiment of the present inventive concept is disclosed. The method includes a first press-fitting step of press-fitting the upper insulating 30 in the cylindrical protruding part of the engine cover 20 (S101). A first vulcanized adhering step applies an adhesive to the lower portion of the insulator 30, the adhesive is melted and the melted adhesive is injected into the cylindrical protruding part 21 (S102). A second vulcanized adhering step applies the adhesive to the lower portion of the vibration absorber 40, and the lower insulator 50 is adhered to the cylindrical protruding part 21 before the vibration absorber 40 is solidified (S103). A second press-fitting step press-fits the mounting bolt protruding part 61 screwed into the engine 10 in the inner space of the lower insulator 50 after the vibration absorber 40 is solidified (S104).

In the first press-fitting step (S101), the stumbling protrusion 22 of the cylindrical protruding part 21 is fitted in the first groove 31 of the upper insulator 30. Further, in the second press-fitting step (S104), the mounting bolt protruding part 61 is fitted in the second groove 51 of the lower insulator 50.

As described above, in accordance with the exemplary embodiments of the present inventive concept, the vibrations due to the abnormal frequency are reduced without mounting the additional damper, and thus, the vibrations from the vehicle body may be reduced. Further, the existing engine cover is used as one mass system, and therefore, the existing product may be applied without being excessively changed.

The foregoing exemplary embodiments are only examples to allow a person having ordinary skill in the art to which the present inventive concept pertains (hereinafter, referred to as “those skilled in the art”) to easily practice the present invention. Accordingly, the present invention is not limited to the foregoing exemplary embodiments and the accompanying drawings, and therefore, a scope of the present inventive concept is not limited to the foregoing exemplary embodiments. Accordingly, it will be apparent to those skilled in the art that substitutions, modifications, and variations can be made without departing from the spirit and scope of the invention as defined by the appended claims and can also belong to the scope of the present invention.

What is claimed is:

1. An engine cover for absorbing vibration, the engine cover enclosing an upper portion of an engine, comprising:
a lower portion provided with a plurality of cylindrical protruding parts;
an upper insulator press-fitted in a cylindrical protruding part of the engine cover to be connected to the engine cover;
a vibration absorber disposed in the cylindrical protruding part and under the upper insulator to absorb vibrations from the engine; and
a lower insulator disposed in the cylindrical protruding part and under the vibration absorber and have an inner space in which a mounting bolt is press-fitted.

2. The engine cover of claim 1, wherein an inside of the cylindrical protruding part is provided with a stumbling protrusion for fixing the upper insulator.

3. The engine cover of claim 2, wherein the upper insulator is provided with a first groove fitted in the stumbling protrusion.

4. The engine cover of claim 1, wherein the inner space of the lower insulator is provided with a second groove in which the mounting bolt is fitted.

5. The engine cover of claim 1, wherein a lower portion of the mounting bolt is screwed into the engine and an upper portion thereof is connected to the lower insulator.

6. The engine cover of claim 5, wherein the upper portion of the mounting bolt includes a mounting bolt protruding part which is press-fitted in the lower insulator to be fitted in a second groove of the inner space of the lower insulator.

7. The engine cover of claim 5, wherein the lower portion of the mounting bolt is provided with a screw fastening part which is screwed into the engine.

8. The engine cover of claim 7, wherein the engine is provided with a fastening groove which is screwed into the screw fastening part of the mounting bolt.

9. The engine cover of claim 1, wherein the vibration absorber holds an inertial effect according to a mass of the engine cover and controls a rigidity to absorb the vibrations.

10. The engine cover of claim 2, wherein the stumbling protrusion has a smaller diameter than a diameter of the cylindrical protruding part.

11. The engine cover of claim 10, wherein a diameter of the upper insulator is smaller than an inner diameter of the cylindrical protruding part and is larger than the diameter of the stumbling protrusion.

12. The engine cover of claim 6, wherein a diameter of the inner space of the lower insulator is larger than that of the mounting bolt protruding part, and a diameter of the second groove is smaller than that of the mounting bolt protruding part.

13. The engine cover of claim 1, wherein the vibration absorber is made of elastomer such as rubber.

14. The engine cover of claim 1, wherein the vibration absorber is connected to the upper insulator by a vulcanized adhering method.

15. The engine cover of claim 1, wherein the vibration absorber is connected to the lower insulator by a vulcanized adhering method.

16. An assembling method of an engine cover for absorbing vibration, comprising:
a first press-fitting step of press-fitting an upper insulator in a cylindrical protruding part of the engine cover;
a first vulcanized adhering step of applying an adhesive to a lower portion of the upper insulator, melting a vibration absorber, and injecting the melted vibration absorber into the cylindrical protruding part;
a second vulcanized adhering step of applying the adhesive to a lower portion of the vibration absorber and adhering a lower insulator to the cylindrical protruding part before the vibration absorber is solidified; and
a second press-fitting step of press-fitting a mounting bolt protruding part screwed into the engine in an inner space of the lower insulator after the vibration absorber is solidified.

17. The method of claim 16, wherein in the first press-fitting step, a stumbling protrusion of the cylindrical protruding part is fitted in a first groove of the upper insulator.

18. The method of claim 16, wherein in the second press-fitting step, the mounting bolt protruding part is fitted in a second groove of the lower insulator.
